(19) United States
(12) Patent Application Publication
(10) Pub. No.: US 2010/0127892 A1
(43) Pub. Date: May 27, 2010

(54) TELEMETRY SYSTEM FOR SHIP PROPULSION SYSTEMS

(75) Inventors: Albert Frederik Wesselink, Wijk en Aalburg (NL); Bob Heerkens, Tilburg (NL); Franciscus Maria Henricus Clermonts, Eindhoven (NL)

Correspondence Address: YOUNG & THOMPSON, 209 Madison Street, Suite 500, Alexandria, VA, 22314, US

(73) Assignees: WARSTSILA PROPULSION NETHERLANDS B.V., Drunen (NL); APPLIED MICRO ELECTRONICS "AME" B.V., Eindhoven (NL)

(21) Appl. No.: 12/515,120

(22) PCT Filed: Nov. 14, 2007
(86) PCT No.: PCT/NL2007/050564

§ 371 Date: Jan. 15, 2010

(30) Foreign Application Priority Data
Nov. 15, 2006 (EP) 06124123.8

(51) Int. Cl. G01M 17/00; H04Q 9/00; G06F 19/00; G05D 1/00

(52) U.S. Cl. 340/870.07; 701/29; 701/21; 700/275

(57) ABSTRACT

Telemetry system for a ship propulsion system with a stationary part and a movable part that is movable relative to the stationary part. The telemetry system includes a processor, a data acquisition unit, at least one sensor, and a local power source. The processor, the at least one sensor and the power source are arranged in the movable part. The at least one sensor can measure an operational state of the movable part. The processor is connected to the at least one sensor for receiving signals from the at least one sensor and can transmit the received signals to the data acquisition unit. The local power source is arranged for providing power to at least one of the processor and at least one sensor, and the transmission of the received signals is arranged by a wireless communication link between the processor and the data acquisition unit.

### FIELD OF THE INVENTION

The present invention relates to a telemetry system for a ship propulsion system. Also, the present invention relates to a method for a telemetry system for a ship propulsion system.

### BACKGROUND OF THE INVENTION

Mechanical failures in large marine machinery such as controllable pitch propellers, steerable thrusters and (diesel) engines are of main concern for the utilization of this machinery. Typically, marine machinery is intended to work under specific conditions, for example at remote locations, under sometimes extreme environmental conditions and for extended periods of time. If in such cases a failure occurs, costs for repair and downtime may be high.

For this reason, the machinery is monitored by a sensor system to observe the condition of the machinery. Typically, the condition is derived from machine parameters such as oil pressure and temperature, process temperature, vibration data, (engine) power, fuel consumption, cooling characteristics, and so on. Based on changes of the condition parameters a condition monitoring system coupled to the sensor system is capable of predicting if and when maintenance or repairs should be performed. By using this prediction system, it becomes, to a large extent, possible to anticipate when a failure may occur and when maintenance should be performed. In this manner both operations and maintenance of the machinery can be planned in a relatively better way, saving both costs and downtime. Predictive and proactive maintenance becomes available by means of such a sensor system.

Sensor systems for controllable pitch propellers and steerable thrusters in marine machinery are hampered in their construction by limiting conditions originating from the mechanical construction of these devices. Propellers and thrusters can rotate relative to the drive shaft, but they may also be rotatable over more than 360° around an axis perpendicular to the drive shaft. Also, propeller blades may have a variable pitch. Similar difficulties in relation to location and construction of the sensor system arise when measurements on rotating parts of a diesel engine, such as its crankshaft, are required.

A prior art condition based monitoring system utilizes an integral measurement technique that records vibrations by at least one sensor at a point on the exterior of the machinery. From characteristics of the vibrations it is attempted to derive one or more sources of the vibrations within the machinery. However, this technique may be adversely affected by mixing and/or damping of signals that propagate towards the at least one sensor.

Also, condition based monitoring systems are known which use a slip ring as contact between one or more sensors on a rotating part and circuitry on a fixed part of the machinery.

Besides condition monitoring for steerable thrusters, there is a similar difficulty for actuation and control of pitch propellers (CPP). A CPP is used in combination with a rudder or a CPP is used in the steerable thruster. Presently, the pitch feed-back is done by a mechanical feed-back of the pitch by means of a feed-back pipe. This has large draw-backs with respect to the accuracy of the pitch setting. The feed-back pipe may be elongated due to temperature changes of the oil around the feed-back pipe and also due to a changing actuating pressure. However, for vessels, it is recognized that dynamic positioned pitch, may have some advantage in improved performance. Adaptation of the pitch of a propeller blade in the propeller wake field, may cause a better efficiency and less emitted noise. This requires an individual actuation and control of each propeller blade. So far, the application of controllable pitch propellers is prevented by a tremendously complicated construction of the required actuation- and sensor-system.

### SUMMARY OF THE INVENTION

It is an object of the present invention to provide an arrangement for a telemetry system that allows measurements at specific points within the marine machinery.

The object is achieved by the arrangement as defined in claim 1.

Advantageously, in a first embodiment this arrangement allows measurement of signals at specific points within the machinery without any restrictions imposed by the mechanical construction of the machinery.

The arrangement is autarctic with respect to its energy requirements. Also, the arrangement allows that signals relating to, for example, vibrations on specific bearings, moisture and/or particles in lubricants, pressure, forces, displacements and temperature, can be measured locally and can be passed along joints that are rotatable over 360° or more.

Also, in a second embodiment, this arrangement allows for a simplification of control and actuation of controllable pitch propellers and adjustable pitch propellers.

Control and actuation of the propeller blades of a controllable pitch propeller, or individual control and actuation of each propeller blade of an adjustable pitch propeller can be done locally in the propeller hub while a tremendous complicated construction for providing control and actuation signals to the propeller can be avoided.

Also, the present invention relates to a method as defined in claim 17.

### BRIEF DESCRIPTION OF DRAWINGS

The invention will be explained in more detail below with reference to a few drawings in which illustrative embodiments of the invention are shown. It will be appreciated by the person skilled in the art that other alternative and equivalent embodiments of the invention can be conceived and reduced to practice without departing from the true spirit of the invention, the scope of the invention being limited only by the appended claims.

FIG. 1 shows a cross-sectional view of a thruster which comprises a first embodiment of the arrangement according to the present invention;

FIGS. 2a, 2b shows a schematic diagram of the telemetry system according to the first embodiment and a further embodiment, respectively;

FIG. 3 shows a detailed partly exploded view of the thruster and arrangement of FIG. 1;

FIG. 4 shows a second block diagram of a mobile portion of the telemetry system of FIG. 1;

FIG. 5 shows a third block diagram of a stationary portion of the telemetry system;

FIG. 6a shows a cross-section of a first embodiment of a power generator of the telemetry system according to the present invention;

FIG. 6b shows a cross-section of a second embodiment of a power generator of the telemetry system according to the present invention;

FIG. 7 shows a cross-sectional view of a controllable pitch propeller arrangement comprising a second embodiment of the telemetry system according to the present invention;

FIG. 8 shows a cross-sectional view of an adjustable pitch propeller arrangement comprising a third embodiment of the telemetry system according to the present invention;

FIG. 9 shows a cross-section of the adjustable pitch propeller of FIG. 8.

### DETAILED DESCRIPTION

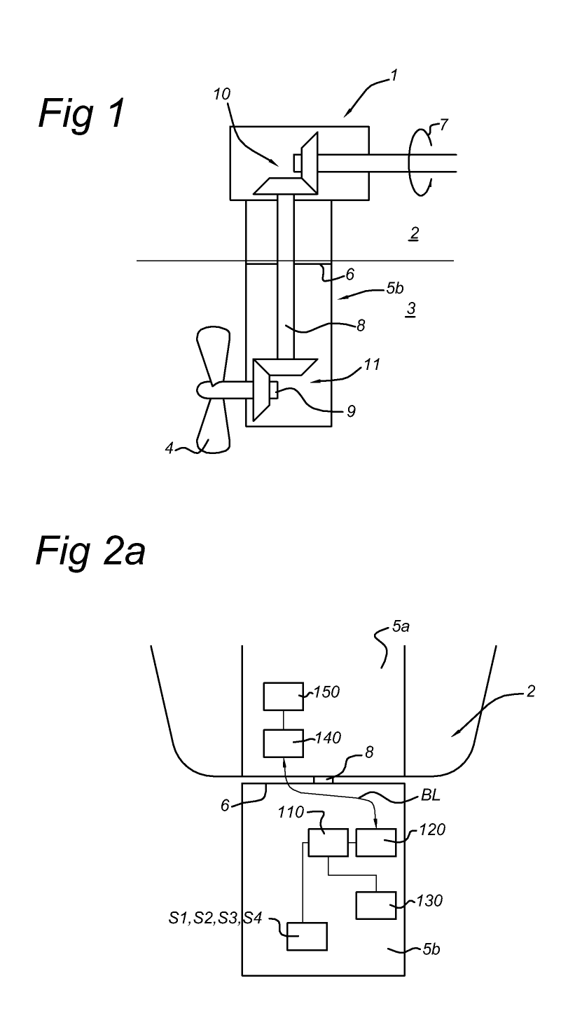

FIG. 1 shows a cross-sectional view of a thruster which comprises a first embodiment of the arrangement according to the present invention.

A marine vessel such as a ship or an oil drilling rig can be provided with a plurality of controllable pitch propellers and steerable thrusters which are capable of maintaining the vessel's position or course during operation. Typically, a thruster is steerable and can be controlled to provide thrust in a given direction relative to the hull of the vessel. The thrust direction and thrust magnitude can be controlled. The thrust magnitude is achieved by installing a fixed pitch propeller driven by a motor or engine, which can vary the rotational speed, or by a controllable pitch propeller. To allow maneuverability of the vessel to an extent as large as possible, the thruster typically is arranged to be rotatable over 360° or more (relative to the longitudinal axis of the vessel).

It is noted that present invention also generally relates to machinery with a first stationary part and a second movable part which is movable with respect to the first stationary part. For example, such machinery may be a propeller as such or a propeller with adjustable blades (controllable pitch propeller), or a crankshaft within an (diesel) engine.

In FIG. 1 an exemplary thruster 1 is shown which comprises a first part 5a that is located within the hull 2 of the vessel and a second part 5b which extends out of the hull 2 into the water 3. The second part 5b comprises a propeller 4.

A first axis 7, connected to an engine (not shown) within the hull 2, is arranged for a rotating connection (through a first drive 10) with a second axis 8.

The second axis 8 extends from the interior first part 5a into the second part 5b. By a second drive 11 the second axis 8 is connected to a third axis (or drive shaft) 9 which can drive the propeller 4.

The first and second part 5a, 5b are separated from each other by a sealing joint 6 that allows rotation of the second part 5b relative to the hull 2 round second axis 8 so as to direct the thrust of the propeller 4 during operation. At the same time the sealing joint 6 provides a seal between the interior of the vessel and the external part 5b of the thruster 1.

Due to the requirement of having high manoeuvrability of the vessel, the second part 5b of thruster 1 is capable of rotation over more than 360° around the second axis 8. Typically, the first, second and third axis 7, 8, 9 and drives 10, 11 each are provided with bearings (not shown). Further, first part 5a and second part 5b contain a liquid medium that surrounds the parts within the first and second part 5a, 5b respectively. Typically, but not limited for this purpose, the liquid medium is a lubricant oil. During operation, the thruster 1 is subjected to intermittent and variable mechanical loading, which may affect the condition of the thruster and may lead to a mechanical failure.

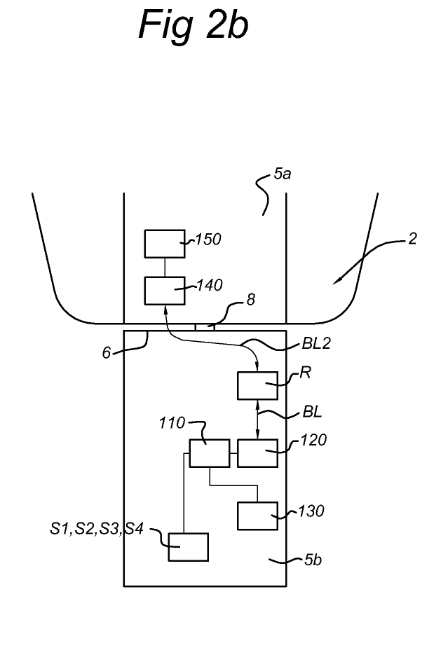

A telemetry system 100 is used to observe the condition of the second part 5b of thruster 1. The telemetry system 100 is described in more detail with reference to FIGS. 2a and 2b.

FIG. 2a shows a schematic diagram of the telemetry system according to the first embodiment.

The telemetry system 100 comprises in the second movable part 5b: a processing unit 110, a communication unit 120, a power generator 130 and a plurality of sensors (schematically indicated by S1, S2, S3, S4).

In the hull of the vessel 2, preferably within the first stationary part 5a, the telemetry system 100 comprises a second communication unit and a further data processing unit 150.

The sensors are arranged for measuring vibrations near roller bearings and bevel or other gears, moisture content, pressure, temperature, viscosity, oil particle sensing, oil analysis or any other type of measurement of machine-related parameter.

The processing unit 110 of the telemetry system 100 is connected to the sensors for receiving their respective signals and for processing the received respective signals. The processing unit is further connected to the communications unit 120 for transmitting and receiving communications signals to the second communication unit 140 within the hull 2 of the vessel. The second communication unit 140 is connected to the further data processing unit 150 within the vessel for display or transmittance of the received signals or results to a storage unit, another telemetry unit or the ship's digital network.

Also, the processing unit 110 is connected to a power source 130 which is arranged for providing energy to the processing unit. The power source 130 of the telemetry system 100 is also located within the second part 5b of the thruster.

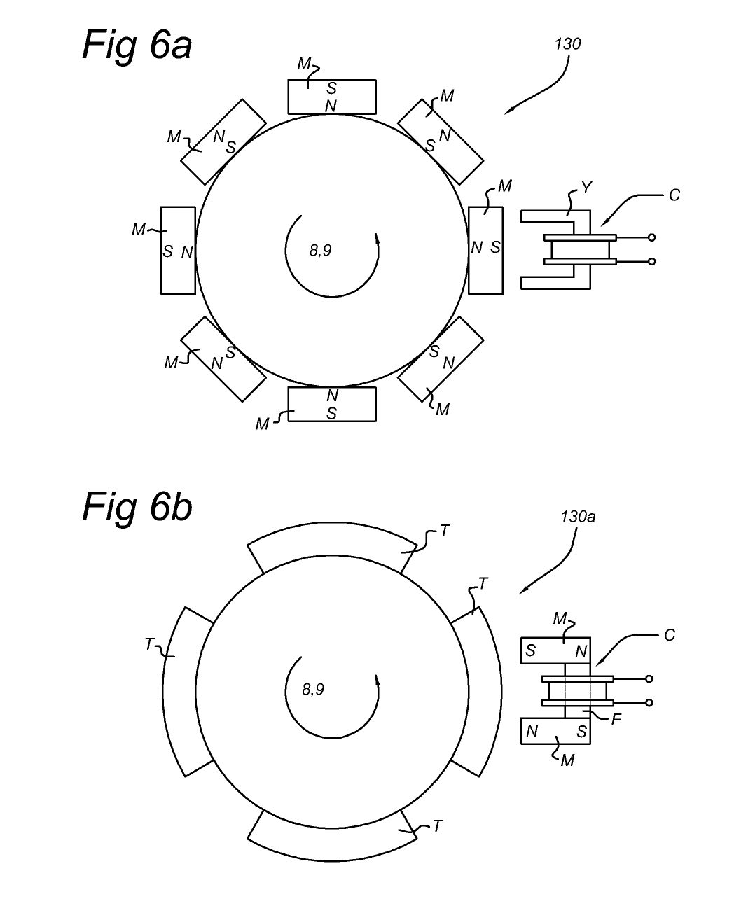

The power source 130 is described in more detail with reference to FIG. 6.

The connection between the processing unit 110 and the sensors and between the processing unit and the communication unit 120 is by wired link. Within the second part 5b of the thruster the processing unit 110, sensors S1, S2, S3, S4 and the communication unit 120 are all in fixed position with respect to each other without any relative movement.

Transmission of signals from the processing unit 110 to the further data processing unit 150 is by wireless bi-directional link (indicated by double arrow BL) between communication units 120, 140.

Advantageously, wireless transmission between the rotatable second part 5b and the stationary part 5a of the thruster in combination with the localized power source 130 removes restrictions relating to the rotation of the second part 5b. Freedom of rotation of the thruster is available which allows the high manoeuvrability required for the vessel.

The wireless transmission can use various types of signals such as radio signals, possibly in the RF range, optical signals, or ultrasound signals.

The transmission path of the wireless link in the telemetry system according to the present invention is typically about 0.5 meter up to about 60 meter.

Experiments show that in such a transmission path wireless transmission can successively be applied to transmit signals through the liquid medium in the second part 5b of the thruster which medium may contain oil, (sea) water and abrasive particles.

Further, within the second part 5b of the thruster wireless signals may pass obstacles such as narrow passages or a curve in the transmission path without significant loss of signal.

FIG. 2b shows a schematic diagram of the telemetry system according to a further embodiment. In FIG. 2b entities with the same reference number as shown in the preceding figures refer to the corresponding entities in the preceding figures.

In the further embodiment, a repeater unit R is provided in the second part of the thruster for repeating transmitted signals, in case the transmission path would be too long for direct transmission between communication units 120, 140. The repeater unit R receives signals from either one communication unit 120, 140 and re-transmits the received signals to the other communication unit. The transmission and re-transmission of signals are schematically indicated by dashed arrows BL, BL2 of wireless links between communication unit 120 and the repeater R and communication unit 140 and the repeater R, respectively.

The repeater unit may be energized by the same power source or power generator 130 as used by the communication unit 120, or the repeater unit may be energized by a dedicated power source or power generator located closely to the repeater unit. Functionally, such a dedicated power generator would be similar to the power generator 130.

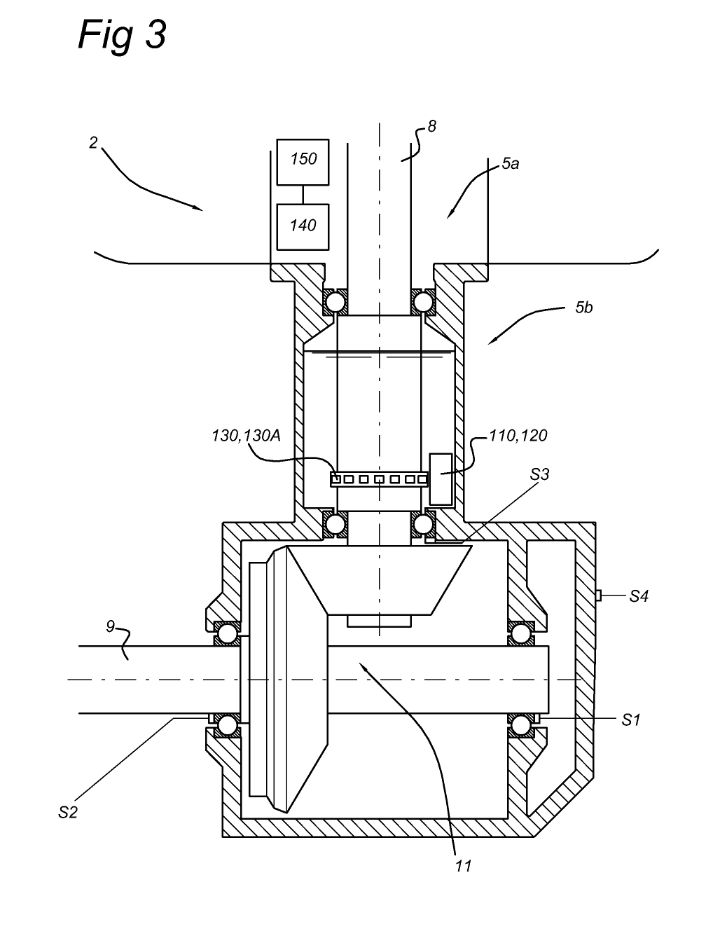

FIG. 3 shows a detailed partly exploded view of the second part of the thruster of FIG. 1 in accordance with the first embodiment.

In FIG. 3 entities with the same reference number as shown in the preceding figures refer to the corresponding entities in the preceding figures.

Sensors S1, S2, S3, S4 are positioned on a number of positions within the thruster 1 to monitor a machine parameter on each position. Typically, one or more accelerometer sensors S1, S2 is positioned in the vicinity of each bearing or gear in the second drive 11 to measure vibrations locally. Also one or more moisture sensors S3 are positioned within the volume of the second part 5b to determine contamination of the lubricant by water (e.g., that may leak into the thruster along the drive shaft 9 of the propeller 4). Further a sensor S4 may be arranged for measuring particles in the lubricant oil, which may be an indication of wear of the thruster.

Also, other sensors such as temperature sensors, pressure sensors or other sensors can be applied on positions within the thruster 1 to measure local temperature or oil pressure, or any other type of measurement of machine-related parameter respectively.

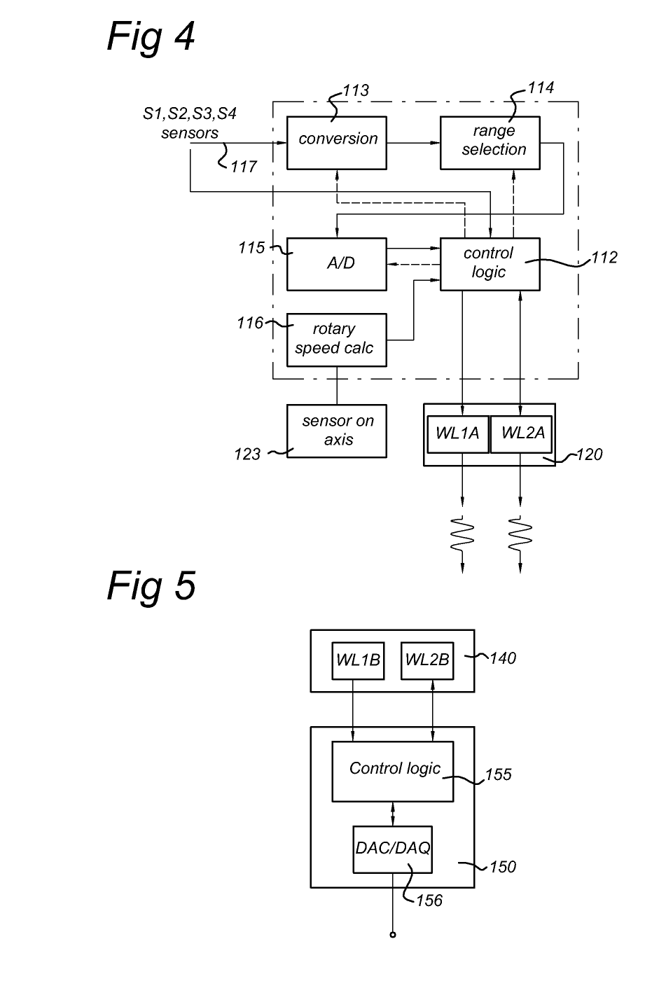

FIG. 4 shows a second block diagram of a portion of the telemetry system of FIG. 1.

In one embodiment, the processing unit 110 within the rotatable second part 5b of the thruster comprises a control logic unit 112, a signal conversion unit 113, a range selection unit 114, an analog-digital converter unit with adequate filtering 115. Also, the processing unit 110 comprises a rotary speed calculation unit 116.

The control logic unit 112 is arranged for collecting signals from sensors and for processing and transmitting the collected sensor signals via the communication unit 120. Also, the control logic unit 112 may be arranged for data-compression of the collected sensor signals and for encryption of the data so as to enhance the robustness of the transmitted signals.

Depending on the type of sensor, sensors may be connected to the processing unit in different ways. Some sensors may be connected directly to a port of the control logic unit 112, since the signals generated by the sensors can be handled directly by the control logic unit. Other sensors may require additional circuitry to adapt the signals of those other sensors to signals suitable for the control logic unit 112.

For example, accelerometer sensors require a conversion for a measured analog signal with a bandwidth of 10 Hz-30 kHz which may be processed, filtered and sampled into the digital domain. Each sensor is connected to a corresponding signal conversion unit 113 by a respective input. The signal conversion unit 113 is connected with its output to an input of the range selection unit 114. The range selection unit 114 is connected with its output to an input of the analog/digital conversion unit 115. An output of the analog-digital conversion unit 115 is connected to an input of the control logic unit 112.

The signal conversion unit 113 is arranged for receiving signals from a sensor 51, S2, S3, S4, converting each received sensor signal in the analog domain and outputting converted sensor signals to the range selection unit 114. Typically, the signal conversion unit 113 is used for conversion of current signals into voltage signals. For example, accelerometer signals may be current signals.

The range selection unit 114 is arranged for selection of a proper digitizing range for the analog-digital conversion unit 115 in order to increase resolution for low amplitude signals from the sensors. A digitizing range selection signal is provided from the range selection unit 114 to the analog-digital conversion unit 115 to select the digitizing range of the analog-digital conversion unit 115.

The analog-digital conversion unit 115 is arranged for converting analog sensor signals into digital sensor signals with a use of the digitizing range selection signal to select a suitable conversion range.

Further, the control logic unit 112 is arranged to control operations of the signal conversion unit 113, the range selection unit 114 and/or the analog-digital converter unit 115 as indicated by the dashed arrows between the control logic unit 112, the signal conversion unit 113, the range selection unit 114 and the analog-digital converter unit 115, respectively.

Additionally, a rotation sensor 123 on the second axis 8 (or alternatively on the drive shaft 9) may provide signals that relate to a rotary speed of the respective axis. The rotary speed signals may be provided to a rotary speed calculation unit 116. The rotary speed calculation unit 116 is arranged for calculating a rotary speed signal. The rotary speed calculation unit is connected to the control logic unit so as to provide the rotary speed signal.

Control logic unit 112 is connected to communication unit 120 for transmission of sensor signals that have been collected form the sensors S1, S2, S3, S4 to the second communication unit 140 within the stationary first part 5a of the thruster 1. In the embodiment shown here, the communication unit 120 comprises a first wireless link unit WL1a and a second wireless link unit WL2a. In this arrangement, the first wireless link unit WL1a is arranged as one-way link for transmission of collected sensor signals (sensor data). The second wireless link unit WL2a is arranged as a two-way link for communication with the further data processing unit 150. The two-way link allows to control the telemetry system remotely for example, to reset the processing unit. Also, the two-way link may be arranged for enabling a reprogramming operation of the processing unit 110.

The one-way link unit WL1a may be provided with a power amplifier to boost the output power.

The data transmission rate of the first and second wireless link unit WL1a , WL2a may be selected based on the amount of data to be transmitted over the corresponding wireless link. The amount of data may depend on the number of sensor signals and/or on the sample rate of individual sensors, and on the processing speed of the processing unit.

The transmission rate of the one-way link transmitted over the first wireless link unit WL1a may be, for example, between 50 b/s and 54 Mb/s depending the character and amount of data, the transmission rate of the two-way link over WL2a may be e.g., between 50 b/s and about 54 Mb/s.

The communication unit 120 may not only transmit data relating to sensor signals, but also additional data that may relate to the operation status of the processing unit.

The processing unit may be embodied by a suitable type of digital system, which may comprise a programmable device such as a field programmable gate array (FPGA), a microprocessor, a microcontroller and/or memory. The memory units may be internal memory of the microcontroller or external memory such as e.g. RAM, (E)EPROM, ROM.

The processing unit comprises its functionality either in hardware or software components to carry out their respective functions as described above. Skilled persons will appreciate that the functionality may also be accomplished by a combination of hardware and software components. As known by persons skilled in the art, hardware components, either analogue or digital, may be present within the processing unit or may be present as separate circuits which are interfaced with the processing unit. Further it will be appreciated by persons skilled in the art that software components may be present in a memory region of the processing unit.

It is noted that the processing unit also may be connected to actuators within the second part 5b. Based on signals received over the 1st communication unit 120, the processing unit may be instructed to output control signals to such actuators.

FIG. 5 shows a third block diagram of a stationary portion of the telemetry system.

The further data processing unit 150 is connected to the second communication unit 140 for receiving data transmitted by the processing unit 110.

The further data processing unit 150 may comprise a second control logic unit 155 and a data acquisition and conversion unit 156.

The second control logic unit 155 is connected to the second communication unit 140 for communication with the communication unit 120 in the second part 5b of the thruster 1. Further, the second control logic unit 115 is connected to the data acquisition and conversion unit 156.

The data acquisition and conversion unit 156 may function as monitoring system that processes the signals from the sensors or may provide output for such a dedicated monitoring system.

The second communication unit 140 comprises a third wireless link unit WL1b and a fourth wireless link unit WL2b. In this arrangement, the third wireless link unit WL1b is arranged as one-way link for reception of collected sensor signals (sensor data) from the first wireless link unit WL1a. The fourth wireless link unit WL2b is arranged as a two-way link for communication with the second wireless link unit WL2a.

It is noted that the further data processing unit 150 may be embodied by any type of computer system, which may comprise a host processor with peripherals. The host processor is connected to memory units which store instructions and data, one or more reading units (to read, e.g., floppy disks, CD ROM's, DVD's), a keyboard and a mouse as input devices, and as output devices, a monitor and a printer. Other input devices, like a trackball, a touch screen or a scanner, as well as other output devices may be provided.

The memory units may comprise various types of memory storage devices such RAM, (E)EPROM, ROM, a tape unit, and hard disk. However, it should be understood that there may be provided more and/or other memory units known to persons skilled in the art. Moreover, one or more of them may be physically located remote from the processor, if required.

The processor may be a single unit, however, it may comprise several processing units functioning in parallel or controlled by one main processor, that may be located remotely from one another, as is known to persons skilled in the art.

The host processor comprises functionality either in hardware or software components to carry out their respective functions as described in more detail below. Skilled persons will appreciate that the functionality of the present invention may also be accomplished by a combination of hardware and software components. As known by persons skilled in the art, hardware components, either analogue or digital, may be present within the host processor or may be present as separate circuits which are interfaced with the host processor. Further it will be appreciated by persons skilled in the art that software components may be present in a memory region of the host processor.

FIGS. 6a and 6b show embodiments of a power generator 130 of the telemetry system.

The environment of the second part 5b in which the telemetry system will be placed can rotate over 360 degrees or more.

Therefore, the electronics of the telemetry system cannot be supplied with power by means of a cable connection from the first stationary part 5a. In order to supply the telemetry system with sufficient power, the power generator 130 is provided which is designed to generate power from the rotation of the second axis 8 (or alternatively the drive shaft 9) which during use is a moving object within the second movable part 5b. The generation of power is done by electromagnetic induction.

FIG. 6a shows a cross-section of a first embodiment of the power generator 130.

On the second axis 8 (or drive shaft 9) a plurality of magnets M are mounted (alternately with an N or S pole extending from the axis surface). At a fixed position relative to the axis an electromagnetic coil C is mounted on a ferromagnetic yoke Y. During operation the axis rotates relative to the coil(s) and the magnetic field created by the magnets M varies at the position of the coil which creates a current in the coil.

The output of the coil C is connected to a rectifier VR1 for rectifying the output signal of the coil and for stabilizing the rectified output signal at a usable output voltage.

The operational range of the power generator may be designed for a rotation speed of the axis 8, 9 between about 100 and about 1000 rpm. The output power of the power generator 130 will depend on the number and size of the magnets M and the (air) gap between a magnet M and the yoke Y.

FIG. 6b shows a cross-section of a second embodiment 130a of the power generator.

In FIG. 6b entities with the same reference number as shown in the preceding figures refer to the corresponding entities in the preceding figures.

In the second embodiment the ferromagnetic yoke Y comprises two magnets M, which are coupled by a ferromagnetic coupling F between an S pole of one magnet M and an N pole of the other magnet M. The ferromagnetic coupling F is enclosed by the electromagnetic coil C.

When a magnetic field generated by the two magnets is sufficiently strong, there is no need for the placements of magnets on the shaft. In that case, an oscillation of the magnetic field within the electromagnetic coil C can be obtained by placement of metal teeth T on the axis 8, 9 that move, during rotation of the axis, along the ferromagnetic yoke Y.

Preferably, the metal teeth T on the axis 8, 9 are made of the same material as the axis, e.g. steel. Alternatively, other metals may be used as well.

It is noted that the power generator 130 of the second embodiment may have a lower efficiency than the power generator of the first embodiment, but depending on the required output power the second embodiment may be preferred due to an easier construction.

Since the generated power will vary with the rotary speed, at lower rotary speed less power will be generated. For this reason, an energy storage device 131 such as a battery can be provided for temporary storage of energy during high rotary speed. In this manner and also by means of a wide voltage input range of the rectifier and the regulating electronics, during low rotary speed, power can be available to the telemetry system.

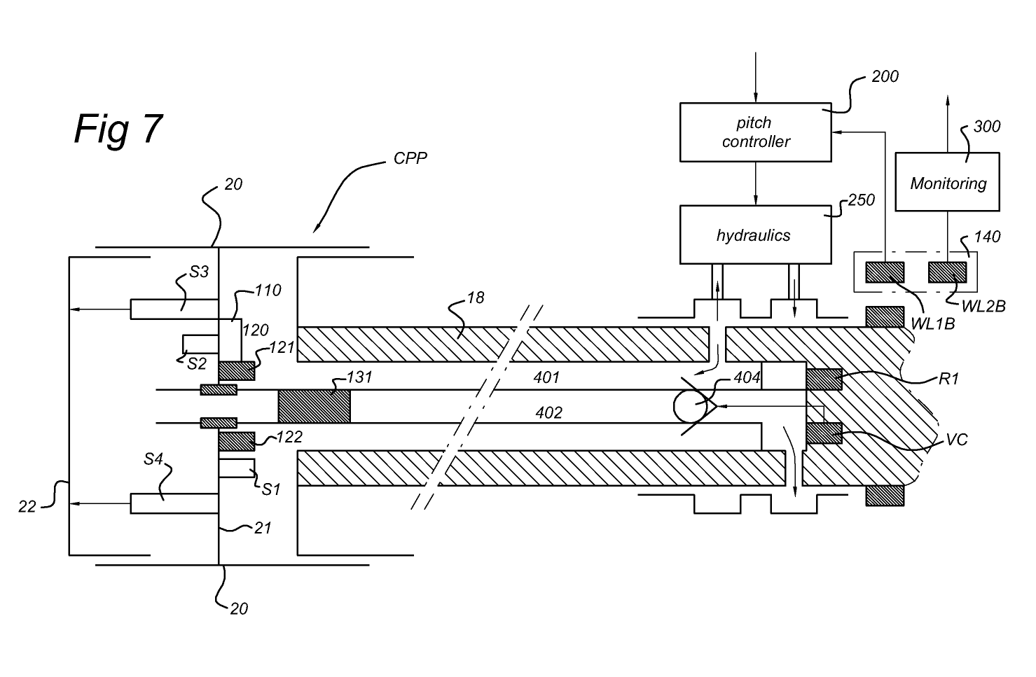

FIG. 7 shows a cross-sectional view of a controllable pitch propeller arrangement CPP which comprises a second embodiment of the telemetry system according to the present invention.

In FIG. 7 entities with the same reference number as shown in the preceding figures refer to the corresponding entities in the preceding figures.

A controllable pitch propeller CPP is configured in that a pitch of the propeller blades is adjustable collectively. The adjustable blades of the propeller (schematically indicated by lines 20) are arranged at an end of a drive axis 18, which at the other end is coupled to an engine (not shown).

The setting of the pitch of the adjustable blades 20 is done by an hydraulic system, which comprises an hydraulic pump 250, a pitch controller 200 and a pitch actuator 21.

The hydraulic pump 250 is coupled to the pitch actuator 21 by means of an hydraulic supply line 401 and an hydraulic return line 402. By pressurizing the supply line 401, the actuator 21 is energized for adjusting the pitch of the blades 20. The hydraulic pump 250 is controlled by pitch controller 200, which will be described in more detail below.

The telemetry system comprises 100 comprises a processing unit 110, a first communication unit 120, a power generator 131 and a plurality of sensors (schematically indicated by S1, S2, S3, S4), and a second communication unit 140.

The first communication unit 120 comprises transmitters WL1a and WL2a. The second communication unit 140 comprises receivers WL1b and WL2b.

The sensors are arranged for measuring pressure (e.g., by S1, S2), and pitch (e.g., by S3, S4).

The pitch of the blades 20 may be measured by measuring a displacement of the sensor S3, S4 relative to a fixed reference in the propeller such as an astern hub cylinder 22 of the propeller housing.

Additional sensors may be present for measuring any other type of machine-related parameter.

The processing unit 110 of the telemetry system 100 is connected to the sensors for receiving their respective signals and for processing the received respective signals. The processing unit 110 is further connected to the first communication unit 120 for transmitting and receiving communications signals to a second communication unit 140 within the hull of the vessel. The second communication unit 140 is connected to the pitch controller 200 within the vessel for display or transmittance of the received signals or results to a storage unit, another telemetry unit or the ship's digital network. Also, the second communication unit 140 may be connected to a monitoring system 300 which is configured to monitor the received signals and to process and analyze the received signals for example for condition based monitoring.

Also, a power source 132 of the telemetry system 100 is arranged within the hydraulic return line 402 within the drive axis 18. The power generator 132 is a turbine for generating electric energy based on the pressure drop over the hydraulic lines 401, 402 of a flowing hydraulic fluid. The power generator 132 is coupled (directly or indirectly) to the circuitry of the components 110, 120, 121, 122, S1, S2, S3, S4 for supplying electric power. The power generator 132 may comprise an energy storage device 131 as described above.

The connection between the processing unit 110 and the sensors and between the processing unit and the communication unit 120 is by wired link. Within the controllable pitch propeller CPP the processing unit 110, sensors S1, S2, S3, S4 and the communication unit 120 are all in fixed position with respect to each other without any relative movement.

Transmission of signals from the processing unit 110 to the further data processing unit 150 is by wireless bi-directional link between communication units 120, 140.

It is noted that at least one repeater unit R1 is arranged along the drive axis 18. The at least one repeater R1 may be energized by power generator 132 (using a cable connection, not shown) or alternatively by a dedicated power generator (not shown) arranged near the at least one repeater.

Within the hydraulic return line 402, a non-return valve 404 may be arranged for preventing a reversed flow of hydraulic fluid in case of loss of hydraulic pressure or loss of control. Basically the non-return valve 404 acts as a safety valve to prevent that in case of loss of hydraulic pressure the pitch of the propeller blades remains constant.

The non return valve 404 may be energized by means of either the power generator 132 or by a valve control unit VC which is also in wireless communication with the telemetry system of the present invention. The valve control may be arranged with a dedicated power generator (not shown). In case of a malfunction the valve control VC may de-energize the non-return valve 404 and shutdown the hydraulic line in order to the preserve the hydraulic pressure in the line

The pitch controller 200 is arranged for controlling the hydraulic pump 250 in such a way that a given pitch is set on the blades 20 of the propeller. By feed-back of the signals from the sensors S3, S4 through the telemetry system a control loop for the pitch controller 200 is created. Based on the signals from the sensors S3, S4 received over the wireless link the pitch controller can adjust its settings in order to control the pitch of the blades of the propeller.

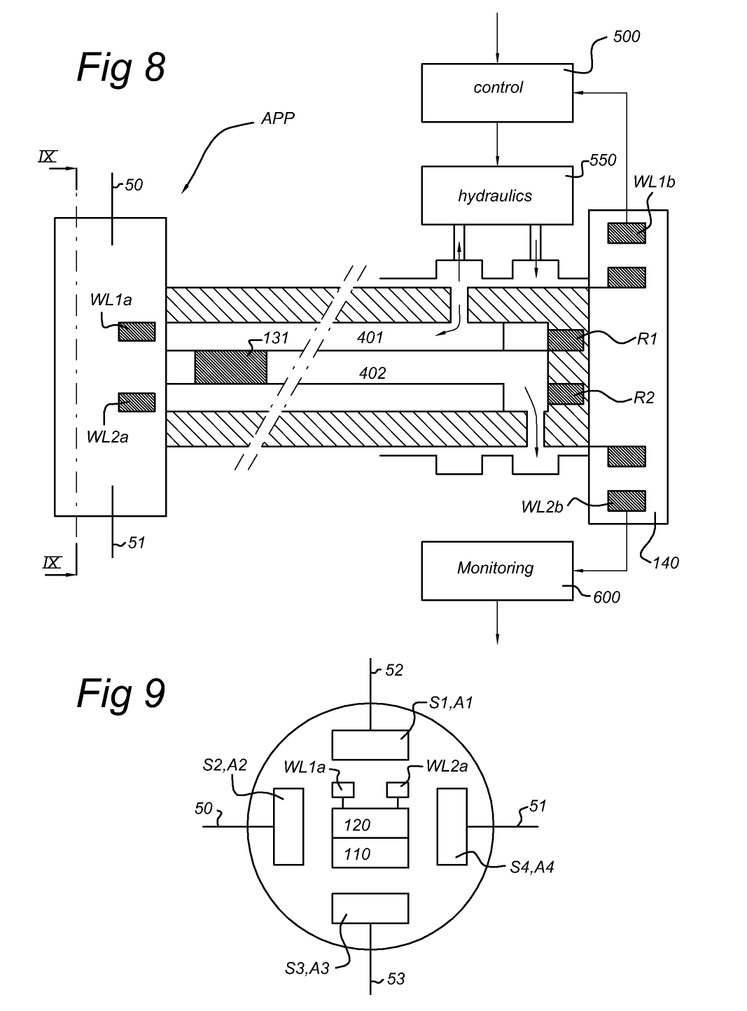

FIG. 8 shows a cross-sectional view of an adjustable pitch propeller arrangement APP which comprises a third embodiment of the telemetry system according to the present invention.

In FIG. 8 entities with the same reference number as shown in the preceding figures refer to the corresponding entities in the preceding figures.

An adjustable pitch propeller APP is configured in that a pitch of each propeller blade is adjustable individually. The adjustable blades of the propeller (schematically indicated by lines 50, 51, 52, 53) are arranged at an end of a drive axis 18, which at the other end is coupled to an engine (not shown).

A cross-section of the adjustable pitch propeller APP along line IX-IX is schematically shown in FIG. 9.

The setting of the pitch of the adjustable blades 50, 51, 52, 53 is done by an hydraulic system, which comprises an hydraulic pump 550 and a controller 500.

The hydraulic pump 550 supplies an flow of a fluid to a power generator 132 (described above) by means of an hydraulic supply line 401 and an hydraulic return line 402. The hydraulic pump 550 is controlled by the controller 500, which will be described in more detail below. The telemetry system comprises 100 comprises a processing unit 110, a first communication unit 120, a power generator 132, a plurality of sensors S1, S2, S3, S4, a plurality of actuators A1, A2, A3, A4, and a second communication unit 140.

The first communication unit 120 comprises transmitters WL1a and WL2a. The second communication unit 140 comprises receivers WL1b and WL2b.

On each blade 50; 51; 52; 53 a sensor S1; S2; S3; S4 and an actuator A1; A2; A3; A4 is arranged (see FIG. 9). Each sensor is arranged for measuring pitch on the respective blade or either alternatively or additionally for measuring lift on the respective blade. Lift relates to the resulting propulsion force exerted by the blade. Each actuator is arranged for setting a given pitch on the respective blade. Each actuator is an hydraulic engine with a servo valve control.

The processing unit 110 of the telemetry system 100 is connected to the sensors for receiving their respective signals and for processing the received respective signals. The processing unit 110 is further connected to the first communication unit 120 for transmitting and receiving communications signals to a second communication unit 140 within the hull of the vessel. The second communication unit 140 is connected to the controller 500 within the vessel for display or transmittance of the received signals or results to a storage unit, another telemetry unit or the ship's digital network. The controller 500 may use the received signals for controlling the hydraulic pump 550.

Also, the second communication unit 140 is coupled to a monitoring system 600 which is configured to monitor the received signals and to process and analyze the received signals and for providing adjustment signals over the wireless link to the actuators. The monitoring system may be arranged to control the pitch of each propeller blade in such a way that during a revolution of the propeller the lift of the blade is substantially constant, which improves the efficiency of the propulsion and reduces vibrations that otherwise would be generated by variations of the lift.

By feed-back of the signals from the sensors S1, S2, S3, S4 through the telemetry system a control loop for the monitoring system 600 is created in relation to the adjustment of the pitch or lift of each blade of the propeller.

The power generator 132 is coupled (directly or indirectly) to the circuitry of the components 110, 120, 121, 122, S1, S2, S3, S4 A1, A2, A3, A4 for supplying electric power.

The connection between the processing unit 110 and the sensors S1, S2, S3, S4 and the actuators A1, A2, A3, A4 and between the processing unit 110 and the communication unit 120 is by wired link Within the adjustable pitch propeller APP the processing unit 110, sensors S1, S2, S3, S4, actuators A1, A2, A3, A4 and communication unit 120 are all in fixed position with respect to each other without any relative movement.

Transmission of signals from the processing unit 110 to the further data processing unit 150 is by wireless bi-directional link between communication units 120, 140.

It is noted that at least one repeater unit R1, R2 is arranged along the drive axis 18. The repeaters R1, R2 may be energized by power generator 132 (using a cable connection, not shown) or alternatively by a dedicated power generator (not shown) in the hydraulic line 401, 402 arranged near the at least one repeater.

While specific embodiments of the invention have been described above, it will be appreciated that the invention may be practiced otherwise than as described. For example, the invention may relate to other type of naval machinery which due to the construction (due to either a rotating element, a moveable element or a relatively large distance between a controller and a controllable element) can not be monitored by wire.

The descriptions above are intended to be illustrative, not limiting. Thus, it will be apparent to one skilled in the art that modifications may be made to the invention as described without departing from the scope of the claims set out below.

1-17. (canceled)

18. Telemetry system for a ship propulsion system; the propulsion system having a stationary part and a movable part that is movable relative to the stationary part; the telemetry system comprising a processing unit, a data acquisition unit, at least one sensor, and at least one power source; the processing unit, the at least one sensor and the at least one power source being arranged in the movable part; the at least one sensor being arranged for measuring an operational state of the movable part; the processing unit being connected to the at least one sensor for receiving signals from the at least one sensor and further being arranged for transmitting the received signals to the data acquisition unit;
the at least one power source being arranged for providing power to at least one of the processing unit and at least one sensor, and the transmission of the received signals being arranged by a wireless communication link between the processing unit and the data acquisition unit,
wherein the at least one power source comprises a power generator which is arranged for generating power, during use, from a moving object within the movable part,
a transmission path of the wireless communication link between the processing unit and the data acquisition unit is between about 0.5 and about 60 meter, and wherein in the transmission path wireless transmission is applicable to transmit signals through a liquid medium in the moveable part (5b), which medium may contain oil, (sea) water and abrasive particles.

19. Telemetry system according to claim 18, wherein the processing unit is connected to a first communication unit within the movable part, and the data acquisition unit is connected to a second communications unit within the stationary part; the first and second communication units being arranged for wireless communication between themselves.

20. Telemetry system according to claim 18, wherein the wireless communication link comprises a one-way wireless link for transmission from the processing unit to the data acquisition unit.

21. Telemetry system according to claim 18, wherein the wireless link comprises a two-way wireless link for transmission between the processing unit and the data acquisition unit.

22. Telemetry system according to claim 18, wherein the at least one sensor is arranged for measuring a condition parameter within the movable part of the propulsion system.

23. Telemetry system according to claim 18, wherein the telemetry system comprises at least one actuator, the at least one actuator being arranged for adjusting a position or a state of an adjustable part within the movable part of the propulsion system; the actuator being controlled by the processing unit.

24. Telemetry system according to claim 23, wherein the adjustment of the at least one actuator is controlled by either a controller unit or a monitoring unit that is coupled to the data acquisition unit.

25. Telemetry system according to claim 18, wherein the at least one sensor comprises at least one of an accelerometer sensor, a lift sensor, a moisture sensor, a temperature sensor, a particle sensor, an oil pressure sensor and a rotary speed sensor.

26. Telemetry system according to claim 18, wherein the power generator comprises at least one magnet (M), an electromagnetic coil (C), the at least one magnet being arranged on the moving object, the electromagnetic coil being arranged in the movable part for receiving magnetic flux from the at least one magnet.

27. Telemetry system according to claim 18, wherein the power generator is a turbine for generating electric energy arranged within an hydraulic line in the moving part, the turbine being energized by a pressure drop of a fluid-flow in the hydraulic line, the flowing fluid being the moving object.

28. Telemetry system according to claim 18, wherein the power source comprises a energy storage device.

29. Telemetry system according to claim 18, wherein the telemetry system comprises within the transmission path at least one repeater unit configured for receiving a signal from one communication unit and for retransmitting the received signal to the other communication unit.

30. Telemetry system according to claim 18, wherein the wireless communication is embodied by one of radio signals, optical signals, or ultrasound signals.

31. Telemetry system according to claim 18, wherein the processing unit is arranged for reprogramming over the wireless communication link.

32. Method for a telemetry system for a ship propulsion system; the propulsion system having a stationary part and a movable part that is movable relative to the stationary part; the telemetry system comprising a processing unit, a data acquisition unit, at least one sensor, and at least one power source; the processing unit, the at least one sensor and the at least one power source being arranged in the movable part, the method comprising:
measuring an operational state of the movable part; receiving signals of the operational state by the processing unit;
transmitting the received signals from the processing unit to the data acquisition unit, the transmission of the received signals being arranged by a wireless communication link, and providing power to at least one of the processing unit and at least one sensor by the at least one power source, wherein the at least one power source comprises a power generator which is arranged for generating power, during use, from a moving object within the movable part,
a transmission path of the wireless communication link between the processing unit and the data acquisition unit is between about 0.5 and about 60 meter, and
wherein in the transmission path wireless transmission is applicable to transmit signals through a liquid medium in the moveable part (5b), which medium may contain oil, (sea) water and abrasive particles.

33. Telemetry system according to claim 19, wherein the wireless communication link comprises a one-way wireless link for transmission from the processing unit to the data acquisition unit.

34. Telemetry system according to claim 19, wherein the wireless link comprises a two-way wireless link for transmission between the processing unit and the data acquisition unit.

35. Telemetry system according to claim 19, wherein the at least one sensor is arranged for measuring a condition parameter within the movable part of the propulsion system.

36. Telemetry system according to claim 19, wherein the telemetry system comprises at least one actuator, the at least one actuator being arranged for adjusting a position or a state of an adjustable part within the movable part of the propulsion system; the actuator being controlled by the processing unit.

37. Telemetry system according to claim 21, wherein the processing unit is arranged for reprogramming over the wireless communication link.
